(19) United States
(12) Patent Application Publication
(10) Pub. No.: US 2010/0217421 A1
(43) Pub. Date: Aug. 26, 2010

(54) Industrial Production Process and Production Tool

(76) Inventors: Norbert Plött, Erlangen (DE); Olaf Ulrich, Erlangen (DE)

Correspondence Address: HARNESS, DICKEY & PIERCE, P.L.C., P.O.BOX 8910, RESTON, VA, 20195, US

(21) Appl. No.: 11/992,765

(22) PCT Filed: Sep. 30, 2005
(86) PCT No.: PCT/DE2005/001747

§ 371 Date: Mar. 28, 2008

(51) Int. Cl. G06F 19/00; G06F 1/28; G06F 17/11

(52) U.S. Cl. 700/104; 700/106; 700/291; 708/446

(57) ABSTRACT

An industrial production method and corresponding production equipment is specified, wherein, for providing the resources and/or energy needed, a load variation y(t) with time is forecast in an automated manner starting with expected environmental and planned production parameters. In at least one embodiment of this process, a forecast for the load variation y(t) with time is generated by linear interpolation in a manner which is clear for the user from parameter sets (p₀, p₁, . . . pₙ) provided with rules (R₀, R₁, . . . Rₙ) for allocating a respective load curve (Y₀(t), y₁(t), . . . yₙ(t)) for an expected parameter set (z).

### PRIORITY STATEMENT

This application is the national phase under 35 U.S.C. §371 of PCT International Application No. PCT/DE2005/001747 which has an International filing date of Sep. 30, 2005, which designated the United States of America, the entire contents of which are hereby incorporated herein by reference.

### FIELD

At least one embodiment of the invention generally relates to an industrial production process and/or to a production tool for production of a production item of any type. The production item may be a consumable object for daily life, or equally an industrially manufactured foodstuff.

### BACKGROUND

For technical implementation of an industrial production process, it is necessary to know the load profile over time. The expression “load profile over time” in this case describes not only the time profile of the power required for production but, in an entirely general form, the time profile of the amount of power, including the facilities required for production. Facilities may, for example, be consumables such as production components, raw materials or small parts such as nuts and bolts. However, the expression facilities also includes the technical gases required for production.

The load profile over time of a production process is governed essentially by the production plan and by environmental conditions. The production plan describes the time at which what amount of the production item should be produced, and therefore includes planned production parameters. The environmental conditions include parameters such as the outside or inside temperature, air pressure, air humidity, precipitation or solar radiation. Environmental parameters such as these influence the production process and must therefore be taken into account for implementation of the production plan. In order to allow the power required for the production process, or the facilities that are required, to be provided at the right time and advantageously, both planned production parameters and environmental parameters to be expected must be taken into account for reliable prediction of the load profile over time.

A series of processes are known for creation of a prediction of the load profile over time of an industrial production process, and therefore for controlling the supply of power or facilities, creating models of the production process in a complex manner. A large amount of effort is disadvantageously required not only for the creation but also for the maintenance of model-based processes such as these.

### SUMMARY

At least one embodiment of the invention specifies an industrial production process wherein a load profile over time is predicted for the provision of the required facilities and/or power, using devices/elements which are simple and in a manner which can be interpreted by and is clear to the user. At least one embodiment of the invention specifies a corresponding production tool for carrying out the production process.

According to at least one embodiment of the invention, an industrial production process is disclosed, wherein a load profile over time is predicted automatically on the basis of environmental and planned production parameters to be expected, in order to provide the required facilities and/or power. The process includes:

a) provision of a number of parameter sets (p₀, p₁, . . . pₙ) from the N environmental and production parameters with a number of rules (R₀, R₁, . . . Rₙ) for respective association of a number of load behavior lines (y(t)₀, y(t)₁, . . . y(t)ₙ),
b) determination of a parameter set z to be expected from the environmental and planned production parameters to be expected,
c) selection of N+1 parameter sets (p₀, p₁, . . . pₙ) which are closest to the parameter set z to be expected,
d) formation of a vector space with N basic vectors (k₁, k₂, . . . kₙ), for which purpose the basic vectors (k₁, k₂, . . . kₙ) are determined as edge vectors using kᵢ=pᵢ−Pᵢ₋₁ from the parameter sets (p₀, p₁, . . . pₙ),
e) determination of weights λi as factors of the parameter sets pi in the vector space with respect to the basic vectors ki,
f) checking whether the parameter set z to be expected is surrounded by the N+1 selected parameter sets (p₀, p₁, . . . p_{N}), with step g) being carried out if the result is positive and with steps c) to e) being repeated if the result is negative, with one of the N+1 selected parameter sets (p₀, p₁, . . . pₙ) being replaced by a more remote parameter set, and
g) determination of the predicted load profile y(t) by linear interpolation, weighted by the weights λi, both over the duration and over the profile of the load behavior lines ((y(t)₀, y(t)₁, . . . y(t)_{N}) which are associated by the rules with the N+1 parameter sets (p₀, p₁, . . . p_{N}).

A first step of at least one embodiment of the invention is in this case based on the idea that a model-based prediction process can produce its predictions in a manner which is incomprehensible to the user by way of internal links, which are not directly comprehensible, between clear databases. By way of example, this is the situation when the prediction of the load profile over time is created by way of a neural network. The basic databases which contain a model of the production process and the changing links between the individual database elements are neither accessible to nor comprehensible by a user. Since the prediction process is based on a model of the production process, both its maintenance and its matching to changing production conditions involve a large amount of effort.

A second step of at least one embodiment of the invention is then based on the idea that a prediction of the load profile over time can be determined for a parameter set z to be expected by appropriate interpolation within the space which is covered, in an imaginary form, by the known parameter sets (p₀, p₁, . . . pₙ) taking into account existing parameter sets (p₀, p₁, . . . pₙ) from environmental and planned production parameters which are each associated with a number of known or measured load behavior lines ((y(t)₀, y(t)₁, . . . y(t)ₙ), using a number of rules (R₀, R₁, . . . , Rₙ). A load behavior line describes the profile of the load over time and is used in the present case for a known load profile in contrast to the load profile to be predicted for the parameter set z.

This results in a parameter set z to be expected, and which is defined by planned production parameters and by expected environmental parameters, being related to parameter sets (p₀, p₁, . . . pₙ) for which rules (R₀, R₁, . . . Rₙ) for association with a time load behavior line ((y(t)₀, y(t)₁, . . . y(t)ₙ) have already been implemented. This makes it possible to produce a prediction for a load profile over time of the production process, based exclusively on information with which the user will be familiar. This is because the output parameters are known load behavior lines for specific predetermined environmental and production parameters.

For interpolation purposes, edge vectors ki which cover a vector space as basic vectors are formed with respect to the known parameter sets. Description of the parameter set z to be expected by way of the basic vectors of the vector space then makes it possible to determine the weights λᵢ of the known load behavior lines, followed by appropriately weighted linear interpolation to obtain the predicted load profile over time of the parameter set z. The number of known parameter sets (p₀, p₁, . . . pₙ) which are used for interpolation purposes is restricted to a number which is greater by one than the number N of parameters, so that the parameter set z can be surrounded in the N-dimensional space of the parameters by these N+1 parameter sets. The N+1 known parameter sets (p₀, p₁, . . . p_{N}) which are closest to the parameter set z are then taken into account for linear interpolation for the prediction of the load profile over time.

The N+1 known parameter sets (p₀, p₁, . . . p_{N}) which contribute to the linear interpolation must therefore on the one hand surround the parameter set z and on the other hand must be closest to the parameter set z, with respect to the further known parameter sets (p₀, p₁, . . . pₙ). Since a load behavior line is described as the value of the load plotted over time, the linear interpolation is used both with respect to the time duration and with respect to the load profile as such.

At least one embodiment of the invention offers the advantage that, based on the choice of the relevant known parameter sets (p₀, p₁, . . . pₙ), only a small amount of configuration effort is required during setting up. In particular, in at least one embodiment, the production process does not need to be modeled. The fundamental knowledge base of the known parameter sets (p₀, p₁, . . . pₙ) and of the rules (R₀, R₁, . . . , Rₙ) for association of the load behavior lines (y₀(t), y, (t) . . . yₙ(t)) contains only measured curves and parameter sets from the user's plan. In contrast to weight parameters when using neural networks, all of these data items are familiar to the user, and can be interpreted by him.

Furthermore, most conventional processes are designed on the basis that the fundamental form of a load behavior line is approximately known in advance, and is just varied on the basis of the predetermined parameters. Furthermore, it is often necessary to assume for this purpose that a specific time cycle exists, such as a daily or weekly cycle. The process described here is not subject to any such preconditions. The predicted load profile over time is obtained from a linear interpolation, in particular at points, of known load behavior lines which have been recorded from environmental and production parameters for specific parameter sets in the parameter space. In consequence and in particular, the creation of the predicted load profile over time is also easily comprehensible by the user.

In this case, it should be stressed in particular that the weights λᵢ are advantageously searched for by solving the equation

$$z = {p}_{0} + {\sum }_{i = 1}^{n} {λ}_{i} \cdot {k}_{i}$$

in which case, in addition to the stipulation of the criterion of surrounding the parameter set z to be expected, use is made of the condition that the weight λ₁ is less than unity, and the weights fall monotonally as i increases, but are greater than zero. If the N+1 parameter sets (p₀, p₁, . . . p_{N}) which are closest to the parameter set z are firstly selected for N parameters, and the described check shows that the selected parameter sets (p₀, p₁, . . . p_{N}) do not surround the parameter set z, then one of the parameter sets being searched for, for example p_{N}, is replaced by a different parameter set, and the selection process is repeated until the weights λᵢ are all less than unity, fall monotonally and are >0.

One possible selection process of at least one embodiment is in this case carried out as follows:

1) all the parameter sets in the rule base are sorted on the basis of their Euclidean distance from the parameter set z.
2) The numbers from 0 to N are used as indices i0 to iN, in this way selecting (pᵢ₀, . . . p_{iN}) of the first N+1 parameter sets from the sorted total number of parameter sets.
3) A check is carried out to determine whether the parameter sets (pᵢ₀, . . . p_{iN}) surround the parameter set z.
4) If yes, the linear interpolation process is carried out. If no, the smallest index i for which pᵢ is included in the total number of selected parameter sets (pᵢ₀, . . . p_{iN}) but pᵢ₊₁ is not is determined. In addition, the index j is determined from the range [0 . . . N] of the parameter set pᵢ within the selected parameter sets (pᵢ₀, . . . p_{iN}).
5) If i+1 is greater than the total number of existing parameter sets, then it is impossible to select from the existing parameter sets N+1 such that they surround the parameter set z, for example because z is not within all the parameter sets which have previously occurred. In this case, by way of example, the load profile associated with z is determined by measurement or by expert opinion, and is included in the rule base. No prediction is possible. If i+1 is less than the total number of existing parameter sets, then the parameter set pᵢ at the point j from [0 . . . N] in the total number of N+1 selected parameter sets is replaced by the parameter set pᵢ₊₁. If j is greater than zero, then the first j selected parameter sets are also replaced by the parameter sets (p0, . . . pj−1). The process then returns to step 3, using the selection of N+1 parameter sets modified in this way.

This example of a process for selection of N+1 parameter sets as the basis for linear interpolation ensures that the N-dimensional space covered by the selected parameter sets is minimal, and that the accuracy of the interpolation process is therefore maximized.

Once the N+1 parameter sets which surround z have been found, then the weights λᵢ that have been found are used for linear interpolation.

In a further advantageous refinement of at least one embodiment, the distances between the parameter sets (p₀, p₁ . . . pₙ) and the expected parameter set z are determined by calculation of the Euclidean distance in the N-dimensional space of the parameters.

In one particularly advantageous embodiment of the invention, the method is carried out on a self-learning basis, with the self-learning process being carried out by predetermining a measured actual load profile y_{M}(t) for a parameter set z as a learning rule, by determining the predicted load profile y(t) for that parameter set z, by comparing the predicted load profile y(t) with the measured load profile y_{M}(t), and by adopting the learning rule for the parameter set z if a defined similarity is undershot.

This refinement makes it possible not to have to transfer any known parameter sets (p₀, p₁ . . . pₙ) in the implementation of the production process to determine the prediction of the load profile over time. If an expected parameter set z is transferred to the system, then, initially, it cannot output any prediction because of the lack of parameter sets (p₀, p₁ . . . pₙ) with associated rules. By measurement of the load behavior line which actually occurs in the case of the parameter set z, this is compared with the non-existing prediction and is stored, since this is not similar, as a known parameter set, for example p₁ with an associated rule R₁. The knowledge base will automatically be filled in this way so that good predictions can be output in a reasonable time. All that is required for this refinement is the provision of occurring load behavior lines in the form of data from a production planning system and/or a consumption measurement point. The parameter sets (p₀, p₁ . . . pₙ) provided with rules (R₀, R₁, . . . Rₙ) can then be determined automatically from this data.

A production tool according to at least one embodiment of the invention uses a prediction module that is formed in order to determine and to output a load profile which has been predicted. For example, the prediction module may be a control unit, a computer or a microchip.

The prediction module is, in at least one embodiment, advantageously networked with a production planning system and a consumption measurement point. This allows the parameter sets (p₀, p₁, . . . pₙ) provided with rules (R₀, R₁, . . . Rₙ) to be brought within the experience of the prediction module on a self-learning basis.

### BRIEF DESCRIPTION OF THE DRAWINGS

Example embodiments of the invention will be explained in more detail with reference to the drawings, in which:

FIG. 1 uses a two-dimensional parameter space to show known parameter sets p as well as a parameter set z to be expected,

FIG. 2 uses a two-dimensional parameter space to show the process of determining edge vectors k,

FIG. 3 uses a three-dimensional space to show the association of rules R and of the load value y(t) at a specific time t with the known parameter sets p,

FIG. 4 shows, schematically, the linear interpolation of known load behavior lines yₙ(t) for prediction of the load profile over time y(t), and

FIG. 5 shows, schematically, a production tool having a prediction module for determining the load profile over time.

### DETAILED DESCRIPTION OF THE EXAMPLE EMBODIMENTS

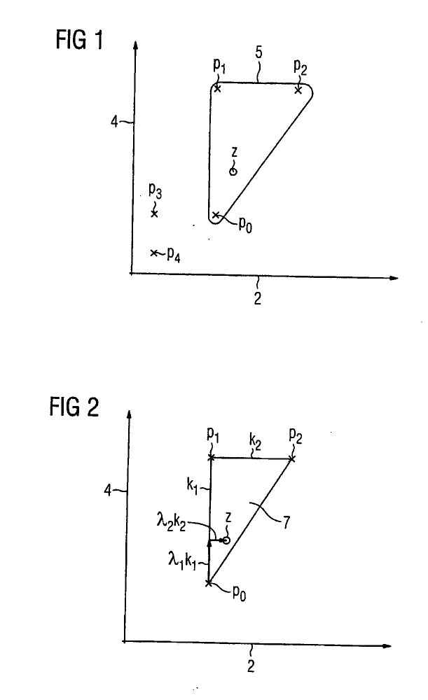

In order to illustrate the production process, FIG. 1 shows a two-dimensional parameter space in the form of a graph, using a coordinate system. An environmental parameter 2, such as the outside temperature, is plotted along the X-axis and a production parameter 4, for example the amount to be produced, is plotted along the Y-axis. Furthermore, five known parameter sets p₀ to p₄ are shown in the coordinate system. Each of these parameter sets is unambiguously associated with an environmental parameter 2 and a production parameter 4. A measured load behavior line is known for each of this total of five parameter sets. In this case, the load behavior line indicates the time profile over which the required power must be supplied to the production process.

Furthermore, a parameter set z to be expected is plotted in the coordinate system shown in FIG. 1, for which a prediction must be output for the load profile over time. The expected parameter set z includes the planned amount of the production item from the production plan as well as prediction of an environmental parameter 2 to be expected at the time of production.

The search for rules which are relevant for the predetermined parameter set z in order to output a prediction of the load profile over time is regarded as a search for the minimum number of already known parameter sets provided with rules in the N-dimensional space which form a body which surrounds the parameter set Z. As can be seen, the minimum number of parameter sets which form a body such as this in an N-dimensional vector space is always equal to N+1.

As can be seen, the expected parameter set z is located between the known parameter sets p₀ to p₂ which surround it. The body envelope curve 5 is shown in order to illustrate this. In the illustrated example, it is also easily possible to see that the known parameter sets p₀ to p₂ from the total of five parameter sets are the three closest parameter sets. As can be seen, the parameter sets p₀ to p₂ that are shown in the N-dimensional space of the parameters are the N+1 parameter sets which are closest to the condition and surround this. In this case, the Euclidean distance is used for distance analysis.

In order to find the rules being searched for the expected parameter set z, a weight must now be defined, on the basis of which the known load behavior lines are superposed. For this purpose, the constellation of known parameter sets p₀ to pₙ provided with rules and the expected parameter set z are regarded as a construction problem, in which the parameter set z must be constructed, from a start parameter set which is predetermined by a start rule and from a vectorial description of the surrounding body. The solution of a construction problem such as this produces N weights for the associated rules. This is illustrated in FIG. 2.

FIG. 2 once again illustrates the two-dimensional parameter space as shown in FIG. 1. This shows the environmental parameter 2, plotted on the X-axis, and the production parameter 4, plotted along the Y-axis. Only the N+1 parameter sets p₀ to p₂ which were closest to the parameter set z according to FIG. 1 and surround it as a body are now shown. In order to solve the construction problem that has been mentioned, the edge vectors (k₁, . . . , kₙ), kᵢ=pᵢ−pᵢ₋ᵢ are now regarded as the basis of an N-dimensional vector space. In this case, that parameter set p₀ which is closest to the parameter set z is used as the starting point. The weights λᵢ are determined by solving the equation based on

$$z = {p}_{0} + {\sum }_{i = 1}^{n} {λ}_{i} \cdot {k}_{i} .$$

During this process, a check is carried out to determine whether the parameter set z is located within or at the edge of the area which is covered by the known parameter sets p₀ to Pₙ. This is true when λ₁≦1 and λ₁≦λᵢ₋₁∀iε[2; n] and λᵢ≧0, that is to say when there is no weight λᵢ greater than unity and the weights fall monotonally as i rises. If this condition is satisfied, then the parameter set z is within the range of the selected parameter sets p₀ to p_{N}, so that in this case a suitable selection of rules has been found for construction of the prediction of the load profile over time. If this condition is not satisfied, then new parameter sets are selected. During this process, the closest parameter set p₀ can always be retained.

FIG. 2 now shows the two edge vectors k₁ and k₂ in the two-dimensional parameter space. The edge vector k₁ links the parameter set p₀ to the parameter set p₁. The second edge vector k₂ links the parameter set p₁ to the parameter set p₂. The parameter set z can now be described as λ₁·k₁+λ₂·k₂ in the vector space 7 covered by the edge vectors k₁ and k₂, as basic vectors. The weights λ₁ and λ₂ for the known rules of the parameter sets p₁ and p₂ for determination of the interpolation of the prediction of the load profile over time at the parameter set z are therefore known from the load behavior lines y₁(t) and y₂(t) which are associated with the parameter sets p₁ and p₂.

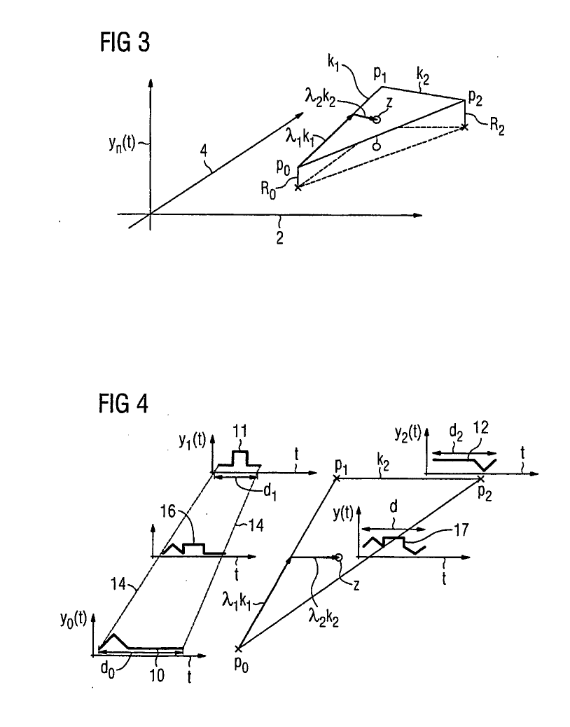

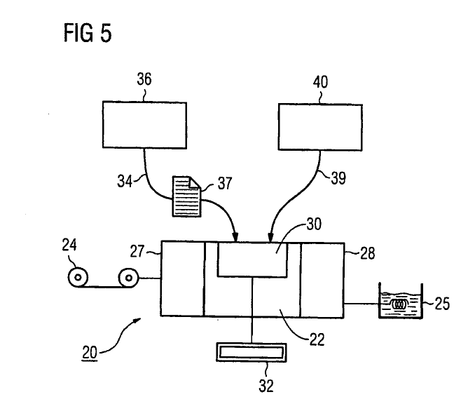

FIG. 3 shows the association between the load behavior lines yₙ(t) and the parameter sets pₙ. This schematically shows, in a third dimension, the load behavior lines yₙ(t) associated with the parameter sets pₙ, for example by means of a load value at a specific time t. For example, a known load behavior line y₀(t) is associated with the parameter set p₀ by means of the rule R₀. This also applies to the parameter set p₂, with which the corresponding load behavior line y₂(t) is associated by means of the rule R₂. The problem is now to use the weights λᵢ that have been found to determine the load behavior line associated with the parameter set z as a prediction of the load profile over time. This is shown in more detail in FIG. 4.

The prediction of the load profile over time for the parameter set z is now determined by means of linear interpolation using the selected parameter sets p₀ to p₂ with which load behavior lines y₁(t) to y₂(t) are associated by way of rules R₀ to R₂. In order to illustrate this procedure, FIG. 4 shows schematically the load behavior lines y₀(t), y₁(t) and y₂(t) respectively as first, second and third load behavior lines 10, 11 and 12. While the first load behavior line 10 has a positive triangular profile, the load behavior line 11 includes a somewhat rectangular profile. The third load behavior line 12 once again has a linear profile with a triangular sink at the end. In order to understand the procedure, the linear interpolation of the load profile over time for the parameter set z will now be broken down into an interpolation along the first edge vector k₁ and a second interpolation along the edge vector k₂.

Starting from the closest parameter set p₀, a linear interpolation is created by means of the first weight λ₁ between the first load behavior line 10 represented by y₀(t) and the second load behavior line 11 corresponding to y₁(t). The weight λ₁ may in this case to a certain extent be regarded as a movement in the direction of the parameter set p₁. Along this path, the time duration changes linearly from the duration d₀ of the first load behavior line 10 to the duration d₁ of the second load behavior line 11. In a corresponding manner, the time duration of the first interpolation of a load profile 16 is located in the distance, indicated by λ₁, between the lines 14 which are shown and each connect the start point and end point of respective first and second load behavior lines 10 and 11. In addition, the curve profile is linearly interpolated, so that the triangular rise in the first load behavior line 10 is flattened with increasing proximity to the second load behavior line 11 while, in contrast, the illustrated rectangle of the second load behavior line 11 grows to an ever greater extent after this. The figure shows a corresponding result for the first interpolation of a load profile 16 with a linearly interpolated time duration and a linearly interpolated curve profile.

In the next step, the weight λ₂ is taken into account, describing the proportion of the third load behavior line 12 in the prediction of the load behavior profile over time. The prediction of the load profile over time 17 with the time duration d as shown is finally obtained taking account of the time duration d₂ of the third load behavior line 12 corresponding to y₂(t). Its time profile is shown by a corresponding linear interpolation. The load profile over time in total includes elements of all three load behavior lines 10, 11 and 12, which are included with different weights in the calculation.

Mathematically speaking, the time duration d of the prediction of the load profile over time is calculated from the time durations (d₀, d₁ . . . dₙ) of the parameter sets (P₀, P₁ . . . Pₙ) provided with rules (R₀, R₁ . . . Rₙ), using the equation:

$$d = {d}_{o} + {\sum }_{i = 1}^{n} {λ}_{i} \cdot ( {d}_{i} - {d}_{i - 1} )$$

The predicted load profile over time y(t) is produced from the load behavior lines (y₀, y₁ . . . yₙ) of the rules (R₀, R₁ . . . Rₙ) such that, for any given time:

$$y ( t ) = {y}_{0} ( {τ}_{0} ) + {\sum }_{i = 1}^{n} {λ}_{i} \cdot ( {y}_{i} ( {τ}_{i} ) - {y}_{i - 1} ( {τ}_{i - 1} ) ) where {τ}_{i} = \frac{t}{d} \cdot di .$$

The described process is supplemented by a learning phase, in which pairs from in each case one parameter set (p₀, p₁ . . . pₙ) and an associated measured load behavior line y_{M}(t) are transferred to the basic system. In this case, the following learning algorithm is carried out for each pair:
1. Create a predicted load behavior line yₚ(t) based on the process as described above for the parameter set.
2. Determine the similarity between the measured and the predicted load behavior line. A similarity measure must be used between the curves for this purpose. The similarity measure takes account of the difference between the two curve durations and the similarity of the curve profile within the joint duration. The similarity measure is defined by the following rule:
   a. The joint duration is d=min(dₚ, d_{M}). A sampling grid over time with m sample points is defined for comparison of the curve profile. The sample times are then given by:

$${t}_{k} = k \cdot \frac{d}{m} .$$

In practice, the curves are generally obtained by sampled individual measurements, and the grid results from the measurement device.
b. Two sample points y_{M}(tₖ) and yₚ(tₖ) are regarded as being equal within a predetermined tolerance ε when:

$$\frac{\vert {y}_{M} ( {t}_{k} ) - {y}_{P} ( {t}_{k} ) \vert}{\vert max ( {y}_{M} ( {t}_{k} ) , {y}_{P} ( {t}_{k} ) ) \vert} < ɛ .$$

c. This comparison process is carried out for all sample points. The number q of points which are not within the tolerance is counted. The similarity of the profile of the curves is

$${S}_{V} = \frac{m - q}{m} .$$

d. The similarity of the curves over time is

$${S}_{T} = \frac{min ( {d}_{M} , {d}_{P} )}{max ( {d}_{M} , {d}_{P} )} .$$

e. The similarity of the curves is S=S_{V}·S_{T}. If the similarity is less than a threshold which can be indicated (for example 5%), the offered learnt data set is also included in the knowledge base. Otherwise, no further learning process is carried out.

The method and basic system cease the learning process when a region of the parameter space is sufficiently densely covered by measurements. A prediction of the load profile over time will then no longer differ sufficiently from a measured load profile. The system determines reliable predictions.

FIG. 5 now shows, schematically, a production tool 20 for carrying out a production process. The production tool 20 includes a central unit 22 for controlling the production process. The production process is illustrated schematically by a production line 24 and a heat bath 25.

In order to control the production line 24 and the heat bath 25, the central unit 22 includes a first control unit 27 and a second control unit 28, respectively.

Furthermore, the central unit 22 has a prediction module which emits a prediction for the time profile of the production process via a connected display unit 32 to the user, in order to provide power or facilities such as consumables, at the right time. In order to determine this prediction, the prediction module 30 is connected via a first connecting line to a production planning system 36, via which it automatically checks parameter sets 37 which comprise planned production parameters and expected environmental parameters. Furthermore, the prediction module 30 is connected via a second connecting line 39 to a measurement point 40, via which it can check measured load behavior lines for self-learning purposes, and for adaptation purposes with self-created predictions.

The evaluation model uses the described process to create a prediction for the load profile over time of the production process, from the parameter sets 37. By checking measured load behavior lines, the evaluation module 30 can improve its own knowledge base on a self-learning basis, in order to output increasingly reliable predictions.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An industrial production process to predict a load profile over time on the basis of environmental and planned production parameters to be expected, to provide required at least one of facilities and power, the process comprising:
a) provisioning a number of parameter sets from N environmental and production parameters with a number of rules for respective association of a number of load behavior lines y(t)₀, y(t)₁, . . . y(t)ₙ;
b) determining a parameter set to be expected from the environmental and planned production parameters to be expected;
c) selecting N+1 parameter sets (p₀, p₁, . . . p_{N}) which are closest to the parameter set to be expected;
d) forming a vector space with N basic vectors, for which purpose basic vectors (k₁, k₂, . . . kₙ) are determined as edge vectors using kᵢ=pᵢ−pᵢ₋₁ from the N+1 parameter sets;
e) determining weights λi as factors of the parameter sets pi in the vector space with respect to the basic vectors ki;
f) checking whether the determined parameter set to be expected is surrounded by the N+1 selected parameter sets, with steps c) to e) being repeated if the result is negative, with one of the N+1 selected parameter sets being replaced by a more remote parameter set; and
g) predicting, upon the result of the check of step c) being positive, the load profile (y(t)) by linear interpolation, weighted by the weights λi, both over the duration and over the profile of the load behavior lines ((y(t)₀, y(t)₁, . . . y(t)_{N}) associated by the rules with the N+1 parameter sets.

2. The production process as claimed in claim 1, wherein the weights λᵢ in step e) are searched for by solving the equation:
$$z = {p}_{0} + {\sum }_{i = 1}^{n} {λ}_{i} \cdot {k}_{i}$$
and, wherein in step 1), the determined parameter set is considered to be surrounded by the parameter sets (p₀, ᵢ, . . . pₙ) if none of the weights λᵢ is greater than unity, and the weights fall monotonally.

3. The production process as claimed in claim 1, wherein, in step c), the respective Euclidean distances between the parameter sets provided with rules and the determined parameter set to be expected are determined, and the parameter sets are sorted on the basis of their determined Euclidean distance, starting from the closest parameter set (p₀).

4. The production process as claimed in claim 1, wherein the parameter sets (p₀, p₁, . . . pₙ) provided with rules are produced in step a) by processing of data from at least one of a production planning system and a consumption measurement point.

5. The production process as claimed in claim 4, wherein the parameter sets (p₀, p₁, . . . pₙ) provided with rules are created on a self-learning basis.

6. The production process as claimed in claim 5, wherein the self-learning process is carried out by determining a measured actual load profile (y_{M}(t)) for a parameter set (z) as a learning rule, by determining the predicted load profile (y(t)) for that parameter set (z) in accordance with steps a) to g), by comparing the predicted load profile (y(t)) with the measured load profile (y_{M}(t)), and by adopting the learning rule for the parameter set (z) if a defined similarity is undershot.

7. The production process as claimed in claim 6, wherein, in order to determine the similarity between the measured load profile (y_{M}(t)) and the predicted load profile (y(t)), sampling is carried out at a number of sample points (m), the difference in the curve values is determined for each sample point, and the number of those sample points for which the difference has a value below a predetermined minimum difference are counted, with the ratio of the time duration of the measured load profile (y_{M}(t)) to the time duration of the predicted load profile ((y(t)) additionally being taken into account.

8. The production process as claimed in claim 1, wherein, in step g), the time duration (d) of the predicted load profile (y(t)) is determined, starting from the time duration (d₀) of the load behavior line (y(t)₀) of the closest parameter set (p₀), by addition of the differences, multiplied by the weights λi, of the time durations (d₀, d₁, . . . dₙ) of the load behavior lines (y(t)₀, y(t)₁, . . . y(t)ₙ) of respectively adjacent selected parameter sets (p₀, p₁, . . . pₙ).

9. The production process as claimed in claim 1, wherein, in step g), the profile of the predicted load profile (y(t)) is determined by determining for a time (t) the value of the predicted load profile (y(t)), starting from the load behavior line (y(t)₀) of the closest parameter set (p₀), by addition of the differences, multiplied by the weights λi, of the values of the load behavior lines (y(t)₀, y(t)₁, . . . y(t)ₙ) of respectively adjacent selected parameter sets (p₀, p₁, . . . pₙ), with normalized times being used in order to determine the respective values.

10. A production tool for carrying out a production process, comprising:
a prediction module, formed to determine and to output a load profile which has been predicted on the basis of the process of claim 1.

11. The production tool as claimed in claim 10, wherein the prediction module is networked with a production planning system and a consumption measurement point.

12. The production process as claimed in claim 2, wherein, in step c), the respective Euclidean distances between the parameter sets provided with rules and the determined parameter set to be expected are determined, and the parameter sets are sorted on the basis of their determined Euclidean distance, starting from the closest parameter set (p₀).

13. The production process as claimed in claim 2, wherein the parameter sets (p₀, p₁, . . . pₙ) provided with rules are produced in step a) by processing of data from at least one of a production planning system and a consumption measurement point.

14. The production process as claimed in claim 13,
wherein the parameter sets (p₀, p₁, . . . pₙ) provided with rules are created on a self-learning basis.

15. The production process as claimed in claim 2, wherein, in step g), the time duration (d) of the predicted load profile (y(t)) is determined, starting from the time duration (d₀) of the load behavior line (y(t)₀) of the closest parameter set (p₀), by addition of the differences, multiplied by the weights λi, of the time durations (d₀, d₁, . . . dₙ) of the load behavior lines (y(t)₀, y(t)₁, . . . y(t)ₙ) of respectively adjacent selected parameter sets (p₀, p₁, . . . pₙ).

16. The production process as claimed in claim 2, wherein, in step g), the profile of the predicted load profile (y(t)) is determined by determining for a time (t) the value of the predicted load profile (y(t)), starting from the load behavior line (y(t)₀) of the closest parameter set (p₀), by addition of the differences, multiplied by the weights λi, of the values of the load behavior lines (y(t)₀, y(t)₁, . . . y(t)ₙ) of respectively adjacent selected parameter sets (p₀, p₁, . . . pₙ), with normalized times being used in order to determine the respective values.
